(19) United States
(12) Patent Application Publication
(10) Pub. No.: US 2026/0280381 A1
(43) Pub. Date: Sep. 17, 2026

(54) MOTOR

(71) Applicant: MINEBEA MITSUMI Inc., Kitasaku-gun, Nagano (JP)

(72) Inventor: Tomoaki NAKANO, Kitasaku-gun, Nagano (JP)

(21) Appl. No.: 19/163,026

(22) PCT Filed: Feb. 9, 2024
(86) PCT No.: PCT/JP2024/004496

§ 371 Date: Sep. 8, 2025

(30) Foreign Application Priority Data
Mar. 10, 2023 (JP) 2023-037905

(51) Int. Cl. H02K 7/08; H02K 7/00; H02K 7/14

(52) U.S. Cl. CPC H02K 7/08; H02K 7/003; H02K 7/14

(57) ABSTRACT

A motor includes a shaft, a yoke including a tube, a stator surrounded by the yoke, a bearing supporting the shaft, and a base holding the bearing. The base is accommodated in the tube of the yoke.

### TECHNICAL FIELD

The present invention relates to a motor.

### BACKGROUND ART

To date, as disclosed in Patent Document 1, a dustproof and waterproof structure to ensure dustproofing and waterproofing inside a motor has been disclosed.

### Citation List

### Patent Literature

Patent Document 1: JP 2004-015918 A

### Summary of Invention

### Technical Problem A known dustproof and waterproof structure is formed by adding a new component to a motor, resulting in an increase in the number of components of the motor.

Thus, an example of an object of the present invention is to provide a motor with a dustproof and waterproof structure capable of suppressing an increase in the number of components.

### Solution to Problem

A motor according to the present invention includes a shaft, a yoke including a tube, a stator surrounded by the yoke, a bearing configured to support the shaft, and a base configured to hold the bearing, wherein the base is accommodated in the tube of the yoke.

### BRIEF DESCRIPTION OF DRAWINGS

FIG. 1 is a perspective view schematically illustrating an external appearance of a motor according to an embodiment of the present invention.

FIG. 2 is another perspective view schematically illustrating the external appearance of the motor according to the embodiment of the present invention.

FIG. 3 is a cross-sectional view of the motor illustrating a cross section taken along a plane including an axial line of the motor according to the embodiment of the present invention.

FIG. 4 is a partial cross-sectional view illustrating the vicinity of an outer circumferential part of a base and a tube of a yoke in FIG. 3.

FIG. 5 is a perspective view of the yoke alone schematically illustrating a configuration of the yoke.

FIG. 6 is a perspective view illustrating a motor in a drone as an application target.

FIG. 7 is another perspective view illustrating the motor in the drone as an application target.

### DESCRIPTION OF EMBODIMENTS

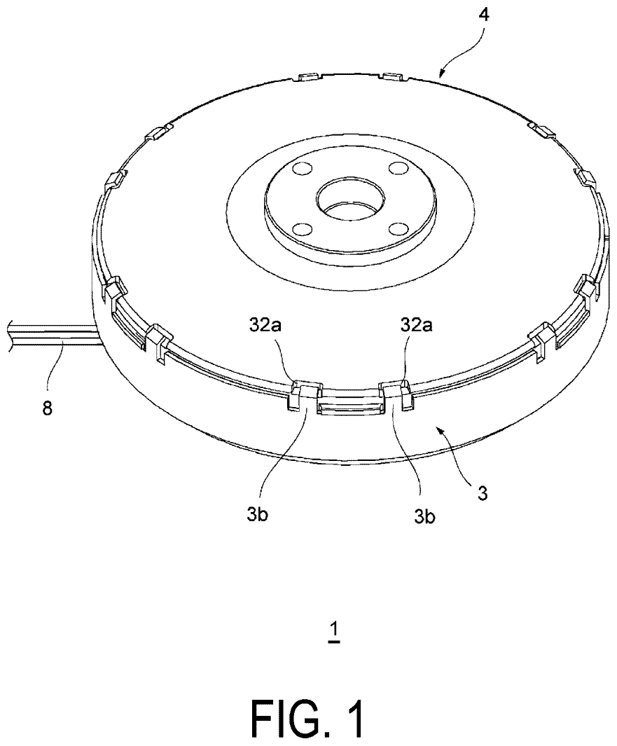

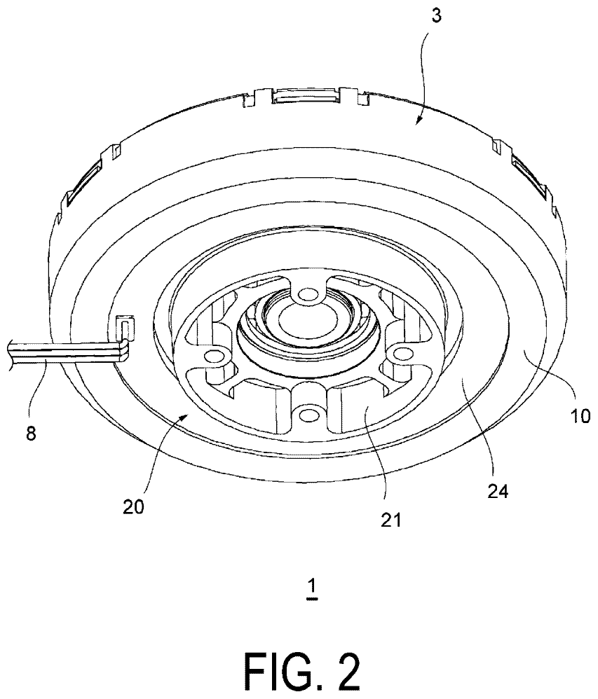

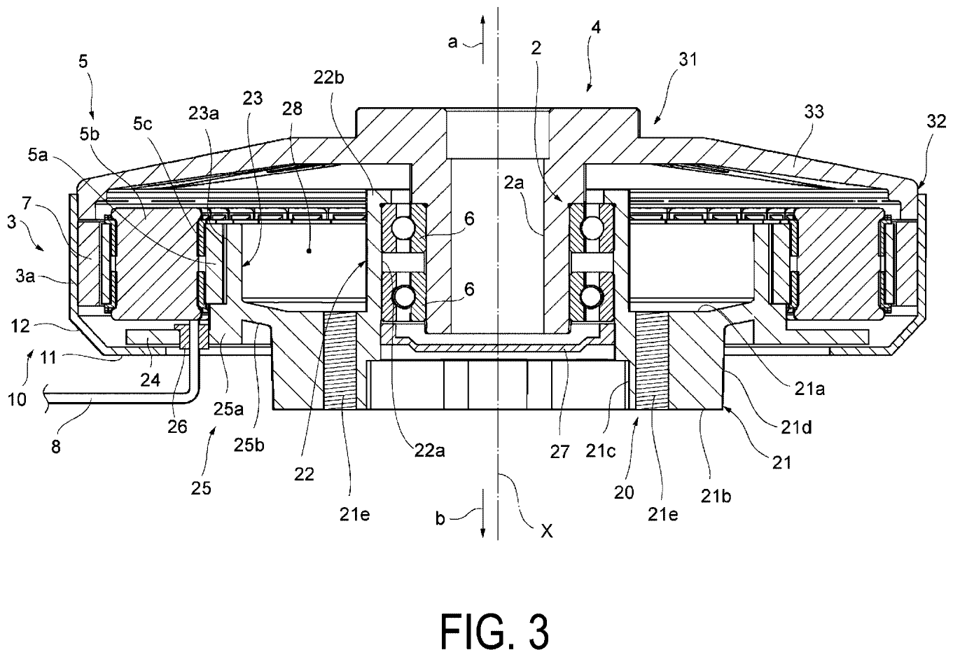

An embodiment of the present invention will be described below with reference to the accompanying drawings. FIG. 1 is a perspective view schematically illustrating an external appearance of a motor 1 according to an embodiment of the present invention, and FIG. 2 is another perspective view schematically illustrating the external appearance of the motor 1. FIG. 3 is a cross-sectional view of the motor 1 illustrating a cross section taken along a plane including an axial line X of the motor 1. As illustrated in FIGS. 1 to 3, the motor 1 includes a shaft 2, a yoke 3 including a tube 10, a stator 5 surrounded by the yoke 3, bearings 6 supporting the shaft 2, and a base 20 holding the bearings 6. The base 20 is accommodated in the tube 10 of the yoke 3. Hereinafter, the motor 1 will be specifically described. Note that, in the drawings, the plurality of members are not all provided with reference signs, and reference signs may be omitted.

The motor 1 is, for example, a brushless motor of an outer-rotor type, and as illustrated in FIGS. 1 to 3, has a flat outer appearance. The motor 1 includes the stator 5 as described above, and also includes a rotor 4. The rotor 4 is rotatably supported by the stator 5 having the axial line X as a rotation axis. Note that in the following description of the present embodiment, an extending direction of the axial line X is referred to as an axial line X direction. Further, in the axial line X direction, one direction side is defined as an upper side, and another direction side is defined as a lower side. The upper side is a side in the direction of arrow a in FIG. 3, and the lower side is a side in the direction of arrow b in FIG. 3. Further, a direction orthogonal to the axial line X is defined as a radial direction. In the radial direction, a side toward the axial line X is defined as an inner circumference side or an inner side in the radial direction, and a side away from the axial line X is defined as an outer circumference side or an outer side in the radial direction. Moreover, a direction around the axial line X is defined as a circumferential direction.

As illustrated in FIGS. 2 and 3, the base 20 is configured to hold the bearings 6 and is also configured to hold the stator 5. The rotor 4 includes a shaft 2 supported by the bearings 6. A magnet 7 and the yoke 3 are attached to a part on the outer circumference side of the rotor 4. The magnet 7 is annular around the axial line X, and the yoke 3 is also annular around the axial line X. The magnet 7 is provided to cover the stator 5 from the outer circumference side via a gap. The yoke 3 is provided to cover the stator 5 from the outer circumference side via the magnet 7. In addition, the yoke 3 includes the tube 10. The tube 10 is a part of the yoke 3, and is a part of the yoke 3 located below the magnet 7 in the axial line X direction.

Specifically, for example, as illustrated in FIG. 3, the base 20 includes a bottom part 21, an inner wall part 22 being a part extending upward from the bottom part 21 at the inner circumference side, an outer wall part 23 being a part extending upward from the bottom part 21 at the outer circumference side, and an outer circumferential part 24 being a part extending from the bottom part 21 toward the outer circumference side.

As described below, the bottom part 21 is a part fixed to a fixed member. The motor 1 is fixed to the fixed member. As illustrated in FIG. 2, the bottom part 21 is an annular part around the axial line X, and includes an upper surface 21a and a lower surface 21b being a pair of surfaces facing away from each other in the axial line X direction, and a pair composed of an inner circumferential surface 21c and an outer circumferential surface 21d facing away from each other in the radial direction. The upper surface 21a and the lower surface 21b are annular surfaces around the axial line X and extend along a plane intersecting the axial line X. The inner circumferential surface 21c and the outer circumferential surface 21d are annular surfaces around the axial line X and are tubular surfaces extending along the axial line X. In addition, the bottom part 21 can be fixed to a fixed member by a fixing member for fixing the bottom part 21 to the fixed member of the motor 1, and for example, is formed with bolt hole parts 21e for screwing a bolt as the fixing member. The bolt hole parts 21e are formed from the lower surface 21b toward the upper surface 21a.

The inner wall part 22 is a part for holding the bearings 6. As illustrated in FIG. 3, the inner wall part 22 is a tubular part extending along the axial line X. An inner circumferential surface 22a being a surface facing the inner circumference side of the inner wall part 22 is a cylindrical surface or a substantially cylindrical surface having the axial line X as a central axis or a substantially central axis. In addition, the inner wall part 22 includes a flange part 22b being an annular part protruding toward the inner circumference side, at an upper end part. As illustrated in FIG. 3, the inner wall part 22 extends upward from the upper surface 21a of the bottom part 21, and extends from an end part on the inner circumference side of the upper surface 21a of the bottom part 21 or from the vicinity of the end part on the inner circumference side. As illustrated in FIG. 3, a space surrounded by the inner circumferential surface 22a of the inner wall part 22 communicates with a space surrounded by the inner circumferential surface 21c of the bottom part 21. Further, as illustrated in FIG. 3, for example, the inner circumferential surface 22a of the inner wall part 22 extends to a lower side in the axial line X direction with respect to the upper surface 21a of the bottom part 21.

The outer wall part 23 is a part for holding the stator 5. As illustrated in FIG. 3, the outer wall part 23 is a tubular part extending along the axial line X. An outer circumferential surface 23a being a surface facing the outer circumference side of the outer wall part 23 is a cylindrical surface or a substantially cylindrical surface having the axial line X as a central axis or a substantially central axis. As illustrated in FIG. 3, for example, the outer wall part 23 is provided at the outer circumference side in the radial direction with respect to the outer circumferential surface 21d of the bottom part 21, and is connected to the bottom part 21 via an annular connecting part 25 extending from the bottom part 21 toward the outer circumference side. As illustrated in FIG. 2, the connecting part 25 includes, for example, a connecting base part 25a and a connecting piece 25b. The connecting base part 25a is an annular part having the axial line x as a central axis or a substantially central axis, and the connecting piece 25b is an annular part connecting the connecting base part 25a to the bottom part 21. The outer wall part 23 extends upward from the connecting base part 25a.

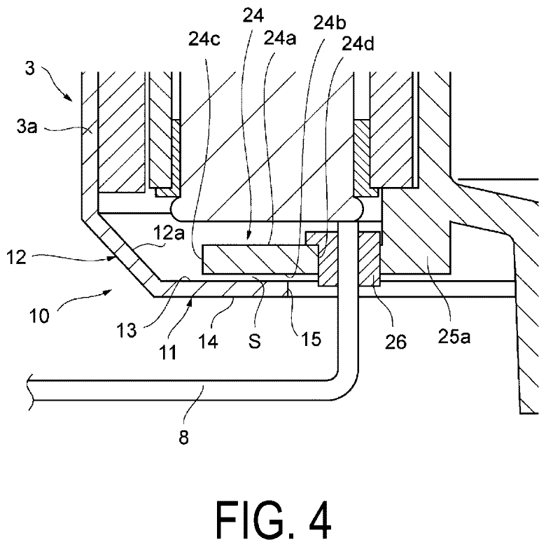

The outer circumferential part 24 is adapted to extend toward an inner surface of the tube 10 of the yoke 3 and to oppose the tube 10 in the axial line X direction. As illustrated in FIGS. 3 and 4, for example, the outer circumferential part 24 is an annular plate-shaped part extending from the connecting base part 25a of the connecting part 25 toward the outer circumference side around the axial line X, and includes an upper surface 24a and a lower surface 24b being a pair of surfaces facing away from each other in the axial line X direction, and an outer circumferential end surface 24c. The upper surface 24a and the lower surface 24b are annular surfaces around the axial line X and extend along a plane orthogonal to the axial line X. The outer circumferential end surface 24c is a surface extending between ends at the respective outer circumference sides of the upper surface 24a and the lower surface 24b, and is an annular surface facing the outer circumference side. The outer circumferential part 24 extends from the connecting base part 25a of the connecting part 25 toward the outer circumference side so that at least an annular part on the outer circumference side of the lower surface 24b opposes the tubular part 10 of the yoke 3 in the axial line X direction. In addition, the lower surface 24b of the outer circumferential part 24 is adapted to oppose the tubular part 10 of the yoke 3 with a gap. Specifically, as illustrated in FIGS. 3 and 4, for example, the lower surface 24b of the outer circumferential part 24 extends parallel or substantially parallel to a plane orthogonal to the axial line X.

As illustrated in FIGS. 3 and 4, the outer circumferential part 24 is formed with a hole part 24d for passing a wiring 8 electrically connected to the stator 5. Note that FIG. 4 is a partial cross-sectional view illustrating the vicinity of the outer circumferential part 24 and the tube 10 in FIG. 3. The hole part 24d is a hole penetrating the outer circumferential part 24 between the upper surface 24a and the lower surface 24b. As illustrated in FIG. 4, the hole part 24d is provided at the inner side in the radial direction with respect to the tubular part 10 of the yoke 3. A bushing 26 is attached to the hole part 24d. The wiring 8 penetrates the bushing 26, and the bushing 26 is adapted to seal between the hole part 24d and the wiring 8 passing through the hole part 24d. Note that the outer circumferential part 24 may be provided with one hole part 24d or two or more hole parts 24d.

The base 20 is a member integrally formed from the same material, and the bottom part 21, the inner wall part 22, the outer wall part 23, the outer circumferential part 24, and the connecting part 25 are each a part of the integrally formed base 20 and are integrally connected. Note that at least one of the bottom part 21, the inner wall part 22, the outer wall part 23, the outer circumferential part 24, and the connecting part 25 may be formed separately from the other parts and may be attached to the other parts to be integrated with the other parts. The base 20 is formed from a non-magnetic material including, for example, a metal material such as aluminum or a resin material.

Note that the forms of the bottom part 21, the inner wall part 22, the outer wall part 23, and the connecting part 25 of the base part 20 are not limited to the above-described forms. In addition, the base part 20 need not include the connecting part 25, and in this case, the outer wall part 23 and the outer circumferential part 24 are directly connected to the bottom part 21. Additionally, in the base part 20, the outer circumferential part 24 may be directly connected to the bottom part 21 without being connected to the bottom part 21 via the connecting part 25.

The motor 1 includes, for example, two bearings 6. As illustrated in FIG. 3, the two bearings 6 are aligned and held in the axial line X direction at the inner circumferential surface 22a of the inner wall part 22 of the base 20. The bearings 6 are fitted into the inner wall part 22 and fixed to the inner circumferential surface 22a of the inner wall part 22 by an adhesive. Note that the bearings 6 may be fixed to the inner circumferential surface 22a of the inner wall part 22 by any method such as press fitting, transition fitting, or clearance fitting. The bearings 6 are ball bearings, for example. Note that the bearings 6 may also be other bearings such as sleeve bearings.

As illustrated in FIG. 3, a pusher 27 formed in a thin plate-like disk shape is fixed to an opening at a lower end of the inner wall part 22 of the base 20. The pusher 27 cooperates with the flange part 22b of the inner wall part 22 of the base 20 to preload the bearings 6. For example, a male screw (not illustrated) is formed on an outer circumferential surface of the pusher 27. On the other hand, a female screw (not illustrated) is formed on the inner circumferential surface 22a of the opening at the lower end of the inner wall part 22. Thus, the pusher 27 is fixed to the opening at the lower end of the inner wall part 22 by being screwed into the opening at the lower end of the inner wall part 22. The pusher 27 is formed from, for example, a metal material such as aluminum or a resin material. Note that the bearings 6 are preloaded by constant-position preloading using the pusher 27, but the method of preloading the bearings 6 is not limited to constant-position preloading using the pusher 27. For example, an elastic member such as a spring or a plate spring may be arranged between the bearings 6 and the pusher 27 or between the bearings 6 and the flange part 22b, and a preload may be applied to the bearings 6 by constant-pressure preloading.

As illustrated in FIG. 3, the stator 5 includes a stator core 5a fixed to the outer circumferential surface 23a of the outer wall part 23 of the base 20, a plurality of coils 5b wound around the stator core 5a, and a plurality of insulators 5c arranged between the stator core 5a and the respective coils 5b. The stator core 5a is formed with a stacked body of silicon steel plates or the like being magnetic materials, and functions as a yoke of the stator 5.

As illustrated in FIG. 3, an annular space 28 is formed between the stator 5 and the inner wall part 22 of the base 20 holding the bearings 6, in the radial direction.

As illustrated in FIG. 3, the rotor 4 includes a substantially disk-shaped holder 31 rotatably supported by the inner wall part 22 of the base 20 of the stator 5 via the bearings 6, 6, the yoke 3 being cylindrical and attached to an outer circumferential end of the holder 31, and an annular magnet 7 attached to an inner circumferential surface of the yoke 3. An inner circumferential surface of the magnet 7 opposes the outer circumferential surface of the stator core 5a of the stator 5 via a gap.

The holder 31 includes the shaft 2 being substantially cylindrical and formed at the inner circumference side, an annular outer circumferential part 32 formed at the outer circumference side, and a connecting part 33 connecting the shaft 2 and the outer circumferential part 32 to each other. The holder 31 is a member integrally formed from the same material, and the shaft 2, the outer circumferential part 32, and the connecting part 33 are each a part of the holder 31 integrally formed, and are integrally connected. The holder 31 is integrally formed from, for example, a metal material such as aluminum or a resin material. Note that in the holder 31, the shaft 2 and the other parts may be formed separately from each other. In this case, the shaft 2 and the other parts are assembled to form the holder 31 integrally.

The shaft 2 is formed in a substantially cylindrical shape having the axial line X as a central axis or a substantially central axis. The shaft 2 includes a through-hole 2a penetrating the shaft 2 from an upper end to a lower end of the shaft 2. The shaft 2 is supported by inner rings of the bearings 6, 6. For example, the shaft 2 is fixed to the bearings 6 by adhesion using an adhesive. Note that the fixing of the shaft 2 to the bearings 6 is not limited to adhesion. For example, the bearings 6, 6 may be fixed to the shaft 2 by any method such as press fitting, transition fitting, or clearance fitting. In addition, the through-hole 2a does not need to be formed in the shaft 2, and the shaft 2 may have a solid cylindrical shape.

The connecting part 33 extends in the radial direction between the shaft 2 and the outer circumferential part 32. The connecting part 33 has a hollow disk shape, and has, for example, a shape with a diameter increasing from the upper side toward the lower side in the axial line X direction.

The outer circumferential part 32 is an annular part around the axial line X, extending downward from the outer circumferential end of the connecting part 33. A lower end of the outer circumferential part 32 is in contact with an upper end of the magnet 7, and the magnet 7 is received in the outer circumferential part 32. As illustrated in FIG. 1, a plurality of engaged parts 32a are formed at an upper end of the outer circumferential part 32 so as to engage with a part of the yoke 3 described below. The engaged parts 32a are, for example, recessed parts.

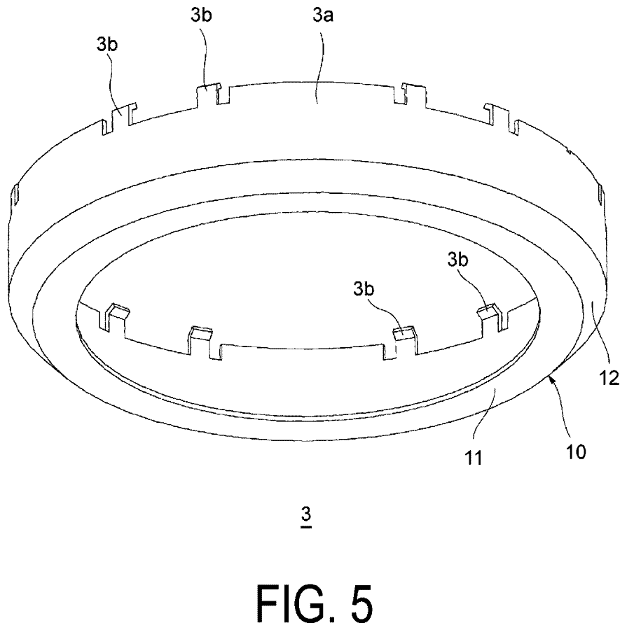

FIG. 5 is a perspective view of the yoke 3 alone schematically illustrating a configuration of the yoke 3. As illustrated in FIGS. 3 and 5, the yoke 3 is an annular member around the axial line X, and extends in a tubular shape along the axial line X. The yoke 3 includes, for example, an attachment part 3a being a cylindrical or substantially cylindrical part having the axial line X as a central axis or a substantially central axis, and a tube 10 being a part extending in a tubular shape along the axial line X. The tube 10 extends downward from the attachment part 3a. The yoke 3 is a member integrally formed from the same material, and the attachment part 3a and the tube 10 are each a part of the integrally formed yoke 3 and are integrally connected. The yoke 3 is formed from a magnetic material such as iron. Note that the yoke 3 may be an endless annular member or an annular member with ends.

A plurality of engaging parts 3b protruding upward are provided at an upper end of the attachment part 3a of the yoke 3. As illustrated in FIGS. 1 and 5, the engaging parts 3b are adapted to engage with the engaged parts 32a formed at the outer circumferential part 32 of the rotor 4. The engaging parts 3b include, for example, parts protruding toward the inner circumference side, and the parts protruding toward the inner circumference side are accommodated in the engaged parts 32a of the rotor 4, so that the engaging parts 3b are engaged with the engaged parts 32a. The yoke 22is attached to the holder 21 by the engaging parts 3b engaging with the engaged parts 32a.

The magnet 7 is attached to the inner circumferential surface of the attachment part 3a of the yoke 3. The magnet 7 is attached to the attachment part 3a by adhesion using an adhesive, for example. The magnet 7 is, for example, a permanent magnet integrally formed from a magnetic material. The magnet 7 has, for example, as illustrated in FIG. 3, a cylindrical shape or a substantially cylindrical shape having the axial line X as a central axis or a substantially central axis. The magnet 7 includes S-pole regions magnetized to an S-pole and N-pole regions magnetized to an N-pole. The S-pole regions and the N-pole regions are alternately arranged in the circumferential direction. The magnet 7 may be formed by annularly forming a single magnet or annularly connecting a plurality of magnets.

The tube 10 of the yoke 3 is adapted to accommodate the base 20 as described above. In addition, the tube 10 of the yoke 3 is adapted such that the outer circumferential part 24 of the base 20 extends toward the inner surface of the tube 10, and the lower surface 24b of the outer circumferential part 24 of the base 20 opposes the tube 10 with a gap in the axial line X direction. As illustrated in FIG. 4, the tube 10 includes, for example, an opposing part 11 being an annular part extending in the radial direction, and a connecting part 12 being a part extending between the opposing part 11 and the attachment part 3a of the yoke 3 and connected to a lower end of the attachment part 3a. The connecting part 12 is an annular part around the axial line X, and has a shape with a diameter decreasing from the upper side toward the lower side in the axial line X direction, as illustrated in FIG. 4, for example. The connecting part 12 is formed such that an inner circumferential surface 12a of the connecting part 12 opposes the outer end part 24c of the outer circumferential part 24 of the base 20 in the radial direction.

The opposing part 11 is a plate-shaped part extending from a lower end of the connecting part 12 toward the inner circumference side. As illustrated in FIG. 4, for example, the opposing part 11 includes an upper surface 13 and a lower surface 14 being a pair of surfaces facing away from each other in the axial line X direction, and an inner circumferential end surface 15. The upper surface 13 is a surface facing upward, and the lower surface 14 is a surface facing downward. The inner circumferential end surface 15 is a surface extending between ends on respective inner circumference sides of the upper surface 13 and the lower surface 14. The upper surface 13 and the lower surface 14 are annular surfaces around the axial line X, and extend along a plane orthogonal to the axial line X. The inner circumferential end surface 15 is an annular surface around the axial line X.

The opposing part 11 of the tube 10 extends toward the inner circumference side so as to oppose at least a part on the outer circumference side of the outer circumferential part 24 of the base 20 in the axial line X direction via a gap S. The gap S has a width allowing the gap S to function as a labyrinth seal, and the opposing part 11 of the tube 10 and the outer circumferential part 24 of the base 20 form a labyrinth structure. Note that the width of the gap S is the width of the gap S in the axial line X direction.

As illustrated in FIG. 4, for example, the opposing part 11 extends to the vicinity of the hole part 24d of the outer circumferential part 24 of the base 20 in the radial direction.

However, the opposing part 11 and the hole part 24d do not overlap each other in the axial line X direction, and the inner circumferential end surface 15 of the opposing part 11 is positioned on the outer side in the radial direction with respect to the hole part 24d. This prevents the opposing part 11 from interfering with the bushing 26 and the wiring 8.

The upper surface 13 of the opposing part 11 is parallel or substantially parallel to a plane intersecting the axial line X, as illustrated in FIG. 4, for example, and the lower surface 24b of the outer circumferential part 24 is parallel or substantially parallel to a plane intersecting the axial line X, as illustrated in FIG. 4, for example. In this case, the gap S functioning as a labyrinth seal is a gap extending in the radial direction and having a uniform or substantially uniform width. The form of the gap S is not limited to this, and may be another form as long as the form functions as a labyrinth seal. For example, the upper surface 13 of the opposing part 11 may be inclined with respect to the radial direction toward the outer circumference side, and similarly, the lower surface 24b of the outer circumferential part 24 may be inclined with respect to the radial direction toward the outer circumference side, and the gap S may be inclined with respect to the radial direction toward the outer circumference side. Specifically, for example, the gap S may be inclined upward or downward with respect to the radial direction toward the outer circumference side. In addition, for example, the upper surface 13 of the opposing part 11 and the lower surface 24b of the outer circumferential part 24 need not be parallel to each other, and the width of the gap S need not be uniform. Specifically, for example, the width of the gap S may increase or decrease toward the outer circumference side. Further, for example, the upper surface 13 of the opposing part 11 may be a curved surface or a combined surface of a curved surface and a flat surface. Similarly, the lower surface 24b of the outer circumferential part 24 may be a curved surface or a combined surface of a curved surface and a flat surface, and the gap S may be a gap along a curved surface or a gap along a combined surface of a curved surface and a flat surface. Further, for example, the upper surface 13 of the opposing part 11 and the lower surface 24b of the outer circumferential part 24 need not have the same shape in a cross section taken along a plane including the axial line X.

The motor 1 has a configuration as described above, and when a current flows through the coils 5b of the stator 5, the rotor 4 rotates around the axial line X with respect to the stator 5 due to interaction with a magnetic field generated by the magnet 7. Thus, a rotating member (not illustrated) attached to the rotor 4 rotates relative to an external device (not illustrated) attached to the stator 5.

In addition, the opposing part 11 of the tubular part 10 of the yoke 3 and the outer circumferential part 24 of the base 20 form the gap S functioning as a labyrinth seal as described above, and have a labyrinth structure. In this way, the gap between the rotor 4 and the stator 5 is the gap S functioning as a labyrinth seal. In addition, the hole part 24d of the outer circumferential part 24 of the base 20 is sealed by the bushing 26, the wiring 8 passing through the hole part 24d. In addition, no hole is formed in the connecting part 33 of the holder 31 of the rotor 4. In this way, the motor 1 has a dustproof and waterproof function.

Further, the labyrinth structure is formed by the yoke and the base being components of the motor, and the motor 1 does not need to add a new component not being a component of the motor in order to form the gap S functioning as a labyrinth seal, thereby not increasing the number of components of the motor 1. Note that the bottom part 21 of the base 20 of the motor 1 is sealed by attaching the bottom part 21 to the fixed member of the motor 1 and bringing the lower surface 21b of the bottom part 21 into contact with the fixed member.

In addition, the gap S functioning as a labyrinth seal is provided at the lower side of the motor 1. The lower side of the motor 1 is relatively less likely to be exposed to foreign matter such as dust, dirt, and water. Therefore, the function of the gap S as a labyrinth seal can be made more effective.

As described above, according to the motor 1 of the embodiment of the present invention, it is possible to provide a motor with a dustproof and waterproof structure capable of suppressing an increase in the number of components.

Next, an assembling method for the motor 1 will be described. The motor 1 is assembled by attaching the bearings 6, the stator 5, the bushing 26, and the like to the base 20, attaching the holder 31 of the rotor 4 to the bearings 6, and then attaching the yoke 3 from the lower side, the magnet 7 being attached to the yoke 3.

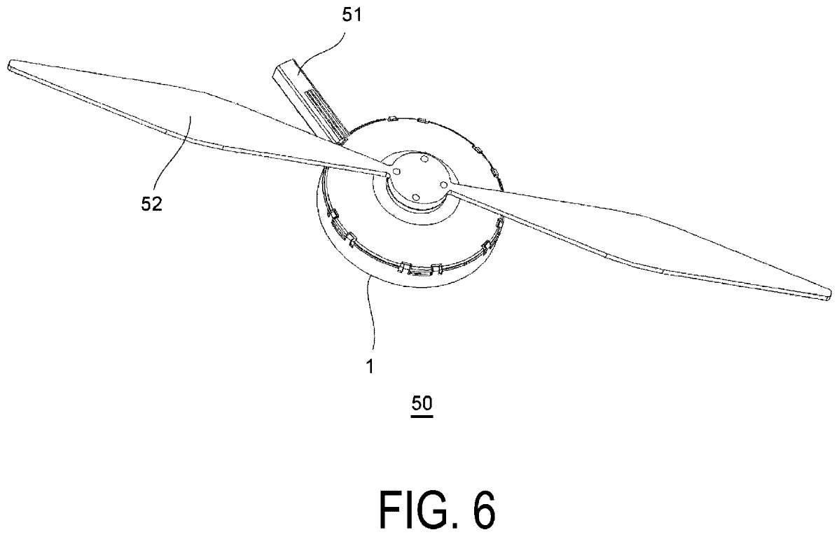

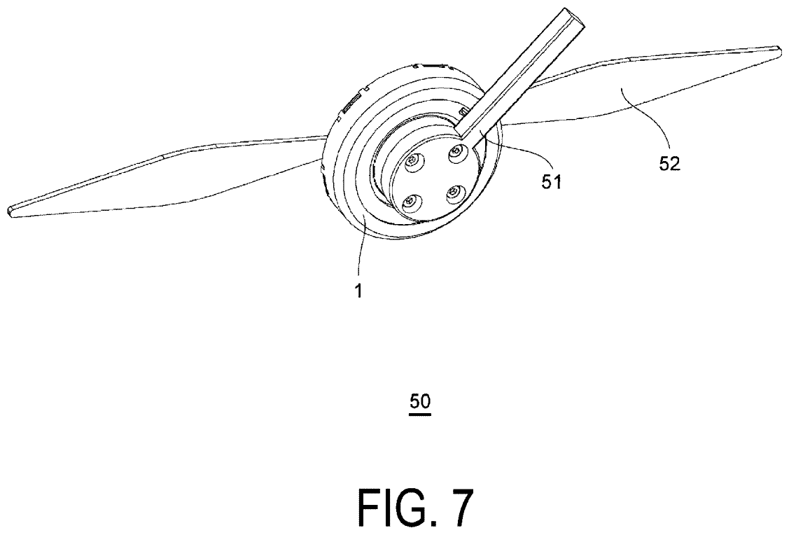

Next, an application target of the motor 1 will be described. The motor 1 is, for example, a motor for a drone, and is used in a drone 50 as illustrated in FIGS. 6 and 7. In the drone 50, the lower surface 21b of the bottom part 21 of the base 20 is fixed to an arm part 51 of the drone 50 being a fixed member of the motor 1, and the motor 1 is attached to the drone 50. In addition, a propeller 52 is attached to the holder 31 of the motor 1. Note that the application target of the motor 1 is not limited to a drone.

Although the present invention has been described through the above embodiments, the technical scope of the present invention is not limited to the scope described in the above embodiments. Various modifications or improvements can be made to the above embodiments, and this is obvious to a person having skill in the art. Such modifications or improvements are also included in the technical scope of the present invention, and this is obvious from the description of the claims.

The above-described embodiments are intended to facilitate understanding of the present invention and are not intended to be construed as limiting. The above-described embodiments do not limit the application target of the present invention, and the present invention may include any objects as the application target. The components included in the above-described embodiments, arrangement, materials, conditions, shapes, sizes, or the like, of the components are not limited to those exemplified and may be appropriately changed.

For example, the present invention includes differences occurring in the implementation of manufacturing tolerances or the like. The components illustrated in the different embodiments can be replaced or combined partially to the extent not technically inconsistent. The components can be appropriately and selectively combined so as to achieve at least part of the objects and the effects described above.

### REFERENCE SIGNS LIST

1: Motor, 2: Shaft, 3: Yoke, 3a: Attachment part, 3b: Engaging part, 4: Rotor, 5: Stator, 5a: Stator core, 5b: Coil, 5c: Insulator, 6: Bearing, 7: Magnet, 8: Wiring, 10: Tube, 11: Opposing part, 12: Connecting part, 12a: Inner circumferential surface, 13: Upper surface, 14: Lower surface, 15: Inner circumferential end surface, 20: Base, 21: Bottom part, 21a: Upper surface, 21b: Lower surface, 21c: Inner circumferential surface, 21d: Outer circumferential surface, 21e: Bolt hole part, 22: Inner wall part, 22a: Inner circumferential surface, 22b: Flange part, 23: Outer wall part, 23a: Outer circumferential surface, 24: Outer circumferential part, 24a: Upper surface, 24b: Lower surface, 24c: Outer circumferential end surface, 24d: Hole part, 25: Connecting part, 25a: Connecting base part, 25b: Connecting piece, 26: Bushing, 27: Pusher, 28: Space, 31: Holder, 32: Outer circumferential part, 32a: Engaged part, 33: Connecting part, 50: Drone, 51: Arm part, 52: Propeller, S: Gap, X: Axial line

1. A motor comprising:
a shaft;
a yoke including a tube;
a stator surrounded by the yoke;
a bearing configured to support the shaft; and
a base configured to hold the bearing, wherein
the base is accommodated in the tube of the yoke.

2. The motor according to claim 1, wherein
an outer circumferential part of the base extends toward an inner surface of the tube, and
the outer circumferential part of the base and the tube oppose each other in a direction of a rotation axis of the shaft.

3. The motor according to claim 2, wherein
a hole part is provided at the outer circumferential part of the base,
a bushing is attached to the hole part, and
a wiring electrically connected to the stator passes through the bushing.

4. The motor according to claim 1, wherein
the base holds the bearing and the stator, and
a space is formed between the bearing and the stator in a radial direction.

5. The motor according to claim 1, comprising:
a rotor, the yoke being attached to the rotor, and a propeller attached to the rotor.
